(19) United States
(12) Patent Application Publication
(10) Pub. No.: US 2020/0272289 A1
(43) Pub. Date: Aug. 27, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Nobuyuki YAMAZOE, Kanagawa (JP)

(73) Assignee: FUJI XEROX CO., LTD., Tokyo (JP)

(21) Appl. No.: 16/554,720

(22) Filed: Aug. 29, 2019

(30) Foreign Application Priority Data
Feb. 27, 2019 (JP) 2019-033500

(51) Int. Cl. G06F 3/0483

(52) U.S. Cl. CPC G06F 3/0483

(57) ABSTRACT

An information processing apparatus includes a sticky note generator and an attachment unit. The sticky note generator is configured to generate, from a task list, a first sticky note corresponding to an attribute of a task, a second sticky note corresponding to a value of the attribute, and a third sticky note corresponding to a task content of the task list. The attachment unit configured to locate the first sticky note and the second sticky note on an axis, and attach the third sticky note at a position corresponding to the second sticky note.

### CROSS-REFERENCE TO RELATED APPLICATIONS

This application is based on and claims priority under 35 USC 119 from Japanese Patent Application No. 2019-033500 filed Feb. 27, 2019.

### BACKGROUND

### (i) Technical Field

The present disclosure relates to an information processing apparatus and a non-transitory computer readable medium.

### (ii) Related Art

JP-A-2011-164696 has an object to provide a network system, a server device, and a groupware program that coordinate various information between functions of a groupware and improve the user's operability. JP-A-2011-164696 describes the followings. That is, a storage stores data appended to an image object in association with a window that is displayed in a superimposed manner. Even if the data appended to the image object is placed in any of plural windows, all the data appended to the image object can be stored in all data items. When an image object in a first window is operated and moved onto a seat image in a seating chart window, a client device sends a request for update of the data appended to the image object to the server device. Then, while inheriting the data appended to the image object, the storage stores the data appended to the image object in a data item, in association with (i) user data appended to the seat image to which the image object is moved or operated to copy and (ii) a message view window.

### SUMMARY

In general, a task list (so called, “ToDo list”) is created in which task contents to be done are sorted out on a predetermined-item by predetermined-item basis. Meanwhile, during a conference, an operation of attaching a sticky note on a mount may be performed using an electronic sticky note system. Aspects of non-limiting embodiments of the present disclosure relate to an information processing apparatus and a non-transitory computer readable medium that, when a task list is discussed during a conference using an electronic sticky note system, associates sticky notes and items of the task list with each other.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including: a sticky note generator configured to generate, from a task list, a first sticky note corresponding to an attribute of a task, a second sticky note corresponding to a value of the attribute, and a third sticky note corresponding to a task content of the task list; and an attachment unit configured to locate the first sticky note and the second sticky note on an axis, and attach the third sticky note at a position corresponding to the second sticky note.

### BRIEF DESCRIPTION OF THE DRAWINGS

Exemplary embodiment(s) of the present disclosure will be described in detail based on the following figures, wherein:

FIG. 1 is a conceptual module configuration diagram of a configuration example of an exemplary embodiment;

FIG. 2 is an explanatory view illustrating a configuration example of a system using the present exemplary embodiment;

FIGS. 3A to 3C are explanatory views illustrating usage examples of an electronic sticky note terminal and an information processing apparatus in a conference room or the like in which the present exemplary embodiment is used;

FIG. 4 is an explanatory view illustrating an example of the data structure of a gathering information table;

FIG. 5 is an explanatory view illustrating an example of the data structure of a mount information table;

FIG. 6 is an explanatory view illustrating an example of the data structure of a sticky note information table;

FIG. 7 is an explanatory view illustrating an example of the data structure of a ToDo management table;

FIG. 8 is an explanatory view illustrating an example of the data structure of an in-mount axis management table;

FIG. 9 is a flowchart illustrating an example of a process according to the present exemplary embodiment;

FIG. 10 is an explanatory view illustrating an example of the data structure of a display ToDo management table;

FIG. 11 is an explanatory view illustrating an example of a process according to the present exemplary embodiment;

FIG. 12 is a flowchart illustrating an example of a process according to the present exemplary embodiment;

FIG. 13 is an explanatory view illustrating an example of the data structure of the display ToDo management table;

FIG. 14 is an explanatory view illustrating an example of a process according to the present exemplary embodiment;

FIG. 15 is an explanatory view illustrating an example of a process according to the present exemplary embodiment;

FIG. 16 is a flowchart illustrating an example of a process according to the present exemplary embodiment;

FIG. 17 is a flowchart illustrating an example of a process according to the present exemplary embodiment;

FIG. 18 is an explanatory view illustrating an example of a process according to the present exemplary embodiment;

FIG. 19 is an explanatory view illustrating an example of the data structure of the display ToDo management table; and

FIG. 20 is a block diagram illustrating an example of a hardware configuration of a computer that implements the present exemplary embodiment.

### DETAILED DESCRIPTION

Hereinafter, an exemplary embodiment of the present disclosure will be described with reference to the accompanying drawings.

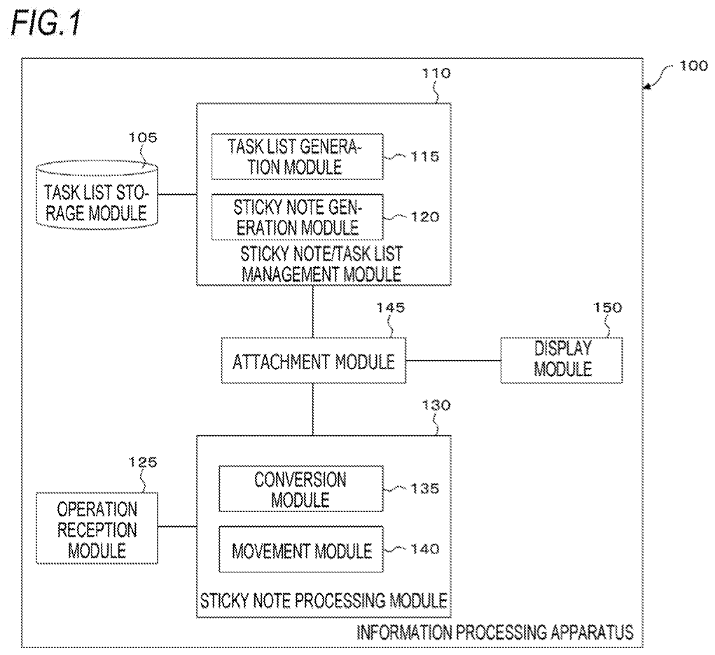

FIG. 1 is a conceptual module configuration diagram of a configuration example of this exemplary embodiment.

As used herein, the term “module” generally refers to a logically separatable component such as software (including a computer program as an interpretation of “software”) or hardware. Therefore, modules in this exemplary embodiment refers to not only modules in a computer program but also modules in a hardware configuration. Therefore, in this exemplary embodiment, description will be made on a computer program that causes a computer to function as a module (a program that causes a computer to execute each procedure, a program that causes a computer to function as each unit, and a program that causes a computer to implement each function), a system and a method. For convenience of explanation, the term “store”, “cause something to store”, and/or an equivalent wording thereto is used. It should be noted that when the exemplary embodiment is a computer program, such terms and wording refer to storing in a storage device or performing control to store in a storage device. In addition, modules may be in a one-to-one correspondence with functions. Alternatively, in implementation, one module may be implemented by one program, or plural modules may be implemented by one program. Conversely, one module may be implemented by plural programs. Further, plural modules may be executed by one computer, or one module may be executed by plural computers in a distributed or parallel environment. Further, one module may include other modules. As used herein, the term “connection” is intended to include not only a physical connection but also a logical connection (for example, a data exchange, an instruction, a reference relationship between data, login, etc.). As used herein, the term “predetermined” refers to the point that an object is determined before a targeted process. Specifically, the term “predetermined” includes the meaning that an object is determined not only before a process according to the present exemplary embodiment starts, but also before a targeted process even after the process according to the present exemplary embodiment starts, according to the situation/state at that time or according to the situation/state so far. When there are plural “predetermined values”, the values may be respectively different or two or more values may be the same (“two or more values” surely including all the values). In addition, a statement “to declare B when A” is used to mean “to determine whether an object is A and to declare B when it is determined to be A”. However, cases where it is unnecessary to determine whether it is A are excluded. Further, when enumerating objects like “A, B, C”, etc., it is an enumeration example unless otherwise mentioned, including a case where only one of the objects is selected (for example, only A).

As used herein, the term “system” or “apparatus” is intended to include not only plural computers, hardware, devices and the like which are connected by a communication unit such as a network (the “network” including a one-to-one correspondence communication connection), but also a single computer, hardware, devices and the like. The terms “apparatus” and “system” are used synonymously with each other. Surely, the term “system” does not include things that are merely a social “structure” which is an artificial agreement (that is, social system).

In addition, for each process performed by each module or for each process when plural processes are performed in the module, target information is read from a storage device, the process is performed and then a result of process is written in the storage device. Therefore, the description about reading from the storage device before processing and writing to the storage device after the processing may be omitted in some cases. The storage device used here may include a hard disk drive, a RAM (an abbreviation for “Random Access Memory”), an external storage medium, a storage device via a communication line, a register in a CPU (an abbreviation for “Central Processing Unit”) and the like.

An information processing apparatus 100 according to the present exemplary embodiment has a function related to a coordination process between task lists and sticky notes. The information processing apparatus 100 includes a task list storage module 105, a sticky note/task list management module 110, an operation reception module 125, a sticky note processing module 130, an attachment module 145 and a display module 150, as illustrated in the example of FIG. 1.

Specifically, the information processing apparatus 100 performs a process regarding a mount and a sticky note that are used at a gathering. Examples of the information processing apparatus 100 includes an electronic sticky note control device, an electronic sticky note system, an electronic white board, and the like. In addition, the sticky note is also referred to as an electronic sticky note, an electronic card, or the like. The information processing apparatus 100 generates a sticky note from a task list.

As used herein, the “gathering” may only need that plural people gather together for conversation. Examples of the “gathering” include a conference, a workshop, a meeting for idea extraction, a meeting for review, a consultation, a discussion, an assembly, a meeting, and the like.

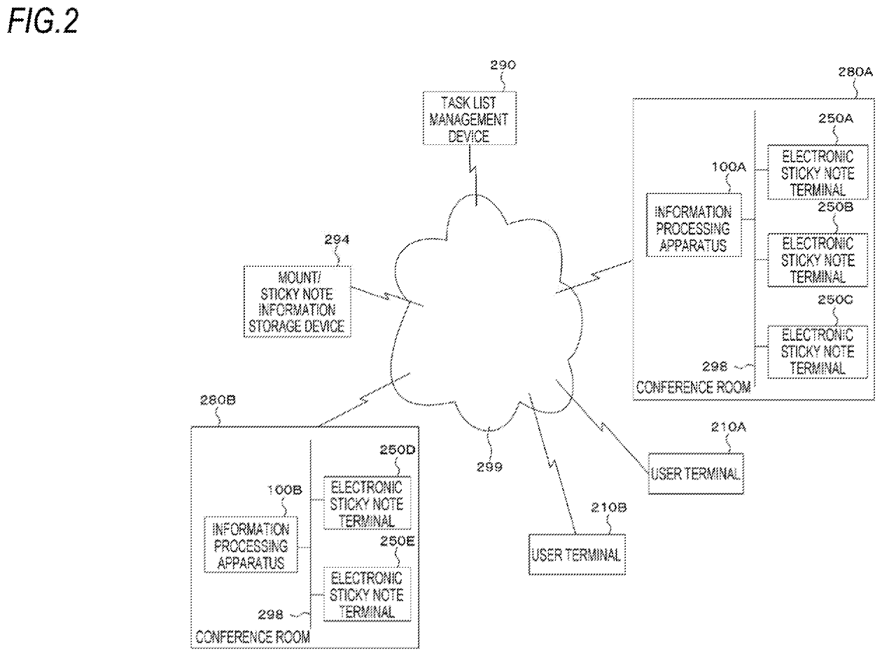

Specifically, the information processing apparatus 100 is used at a gathering that is performed by a facilitator (generally, one person) and plural participants using sticky notes. Each participant uses an electronic sticky note terminal 250 as a participant's terminal to create a sticky note in which an idea or the like is described. Generally, as illustrated in the example of FIG. 2, as the electronic sticky note terminal 250, there are plural electronic sticky note terminals 250A, 250B, and the like possessed by the respective participants (hereinafter, representatively referred to as electronic sticky note terminals 250). Then, the information processing apparatus 100 receives sticky notes from the electronic sticky note terminals 250 and attaches the sticky notes on a mount (or a background). The facilitator uses a shared screen, which is a display device of the information processing apparatus 100, (i) to determine or change the positions of the sticky notes on the mount, (ii) to put the sticky notes together (“putting the sticky notes together” is also referred to as associating the plural sticky notes, grouping the sticky notes, or the like), to (iii) to create sticky note information by him/herself, and the like, and proceeds with the gathering. In the present exemplary embodiment, one of the participants may be the facilitator.

The sticky note/task list management module 110 includes a task list generation module 115 and a sticky note generation module 120, and is connected to the task list storage module 105 and the attachment module 145. The sticky note/task list management module 110 associates a task list in the task list storage module 105 with sticky notes. Specifically, a task list is generated from sticky notes, and sticky notes is generated from a task list.

The task list storage module 105 is connected to the sticky note/task list management module 110. The task list storage module 105 stores the task list. Here, the term “task list” refers to an array in which task contents to be done are sorted out and arranged on a predetermined-item by predetermined-item basis. The “task list” has at least one attribute. A ToDo list corresponds to a specific example of the task list. Further, a deadline date, a person in charge, importance and the like correspond to specific examples of the attributes.

The task list storage module 105 may be provided in the information processing apparatus 100, or may be provided in the task list management device 290 via a communication line as illustrated in the example of FIG. 2.

The sticky note generation module 120 generates, from the task list, a first sticky note corresponding to the attribute of a task, a second sticky note corresponding to a value of the attribute, and a third sticky note corresponding to a task content of the task list.

Here, the “first sticky note” is a sticky note in which an attribute (or an attribute name) is written. In the above-described example, a sticky note in which contents such as a “deadline date”, a “person in charge”, and “importance” are written corresponds to the first sticky note.

The “second sticky note” is a sticky note in which an attribute value is written. A sticky note in which “Mr. A”, “Mr. B” or the like who is a specific person in charge is written as an attribute value of a “person in charge” corresponds to the second sticky note.

The “third sticky note” corresponds to the task contents of the task list. The term “task contents of the task list” is the “task to be done” described above. For example, a sticky note in which the contents of a task to be done by Mr. A who is in charge are written and which is attached at a position of the intersection between a first sticky note of the “person in charge” on a first axis and a second sticky note of “Mr. A” on a second axis in a plane space defined by the two axes corresponds to the third sticky note.

In addition, when a task content in which an attribute value is not set exits, the sticky note generation module 120 may generate a second sticky note indicating that an attribute value is not set. Specifically, a sticky note in which “Not Assigned” (which will be described later) is written or the like corresponds to the second sticky note indicating that the attribute value is not set.

The task list generation module 115 generates a task list from the first, second and third sticky notes attached on the mount. That is, while the sticky note generation module 120 generates a sticky note from a task list, a process of generating a task list from a sticky note, which is the reverse process, is performed. Specifically, an attribute of a task list may be set based on a sticky note which is located in the vicinity of a vertical axis or a horizontal axis on the mount and whose type is the first sticky note. An attribute value of the task list may be set based on a sticky note located in the vicinity of the vertical axis or the horizontal axis on the mount and whose type is the second sticky note. Task contents may be set based on a third sticky note located at a position corresponding to the position of the second sticky note on the mount. When there are the vertical and horizontal axes, a second sticky note on the vertical axis and a second sticky note on the horizontal axis corresponding to the position of the third sticky note may be extracted, and task contents may be set to have an attribute value of the second sticky note on the vertical axis and an attribute value of the second sticky note on the horizontal axis. When there are the vertical and horizontal axes, the third sticky note is located at a position where the position of the second sticky note on the vertical axis and the position of the second sticky note on the horizontal axis intersect with each other.

The operation reception module 125 is connected to the sticky note processing module 130. The operation reception module 125 receives a user's operation. As the user's operation, there are an operation related to generation of a sticky note, an operation related to a sticky note already attached on the mount, and the like. For example, the operation reception module 125 controls a liquid crystal display which also serves as a touch panel displaying the mount and sticky notes to receive the user's operation. In addition, the user's operation using a mouse, a keyboard, a camera, a microphone and the like (including sight line, gesture, voice and the like) may be received.

The sticky note processing module 130 includes a conversion module 135 and a movement module 140, and is connected to the operation reception module 125 and the attachment module 145. The sticky note processing module 130 performs a process related to a sticky note. For example, there are a sticky note generation process, a movement process, a deletion process, and the like.

When a sticky note generated by an operator is attached at a position corresponding to a second sticky note, the conversion module 135 converts the sticky note into a third sticky note.

When a second sticky note is moved, the movement module 140 moves a third sticky note along with the movement of the second sticky note.

The attachment module 145 is connected to the sticky note/task list management module 110, the sticky note processing module 130, and the display module 150. The attachment module 145 locates a first sticky note and a second sticky note on an axis and attaches a third sticky note at a position corresponding to the second sticky note.

Here, as the “axis”, there is a vertical axis or a horizontal axis.

As “locating the first sticky note and the second sticky note on an axis”, plural second sticky notes may be located on a straight line serving as the axis, and first sticky notes may be located at positions indicating the attributes of the second sticky notes. Further, the phrase “on a straight line” does not have to refer to a strictly straight line but may refer to an extent that it may be recognized that plural sticky notes are located on an axis. The position of a first sticky note (a position indicating the attribute of a second sticky note) may be around the axis. For example, the position of the first sticky notes is the beginning or the end of the arrangement of second sticky notes or is around the center of the arrangement of the second sticky notes.

In addition, the attachment module 145 may locate the first sticky note corresponding to a selected attribute and the second sticky note on the axis.

The term “selected” (select, selection) in the “selected attribute” may refer to an attribute selected by a user or a predetermined attribute.

Furthermore, the attachment module 145 may locate a first sticky note corresponding to a non-selected attribute at a location different from the axis. The phrase “location different from the axis” is a position which has no relation with positions on the axis and is a location which is not in a space defined by the axis. For example, when the vertical axis is displayed at the left end and the horizontal axis is displayed at the upper end, the lower right position other than the space defined by the axes corresponds to the “location different from the axis”. By displaying the sticky note of the non-selected attribute on the mount, it becomes possible for the user to know that an attribute exists other than the attribute displayed as the axis. Then, the attribute which is not selected as the axis may be adopted as an axis.

In addition, when two attributes are selected, the attachment module 145 may attach the first, second and third sticky notes while assigning one of the two attributes to the vertical axis and the other of the two attributes to the horizontal axis.

The display module 150 is connected to the attachment module 145. The display module 150 displays a mount, sticky notes and the like on a screen. For example, the display module 150 controls the liquid crystal display that also serves as the touch panel, to display the mount and the sticky notes and present a message or the like to the user. In addition, sound may be output by a speaker, or a message may be presented to the user by a tactile sensation using a haptic device.

FIG. 2 is an explanatory view illustrating a configuration example of a system using the present exemplary embodiment. The information processing apparatus 100 generally includes a display device having a large screen and is operated by the facilitator. The display device is controlled by the display module 150 and is visible to all participants. Each electronic sticky note terminal 250 is operated by a participant in a gathering. Generally, each participant holds one electronic sticky note terminal 250. For example, a tablet type terminal or the like is used as the electronic sticky note terminal 250.

In the example of FIG. 2, an information processing apparatus 100A, an electronic sticky note terminal 250A, an electronic sticky note terminal 250B, and an electronic sticky note terminal 250C are provided in a conference room 280A to perform a gathering. The information processing apparatus 100A, the electronic sticky note terminal 250A, the electronic sticky note terminal 250B, and the electronic sticky note terminal 250C are connected to each other via a communication line 298. The communication line 298 may be a wireless communication line, a wired communication line, or a combination of the wired and wireless communication lines, and is, for example, the Internet, an intranet or the like as a communication infrastructure.

Further, an information processing apparatus 100B, an electronic sticky note terminal 250D, and an electronic sticky note terminal 250E are provided in a conference room 280B to perform a gathering, which is performed separately from that in the conference room 280A. The information processing apparatus 100B, the electronic sticky note terminal 250D, and the electronic sticky note terminal 250E are connected to each other via a communication line 298.

In addition, a user terminal 210A, a user terminal 210B, the task list management device 290, a mount/sticky note information storage device 294, the devices in the conference room 280A, and the devices in the conference room 280B are connected to each other via a communication line 299. The communication line 299 may be a wireless communication line, a wired communication line, or a combination of the wired and wireless communication lines, and is, for example, the Internet, an intranet, or the like as a communication infrastructure. Functions of the task list management device 290 and the mount/sticky note information storage device 294 may be implemented as a cloud service.

The task list management device 290 includes the task list storage module 105 and supplies a task list to each information processing apparatus 100. The task list management device 290 is also referred to as a ToDo management device or the like. Each information processing apparatus 100 may perform a process using the task list management device 290. In this case, the task list in the task list management device 290 may be shared by plural information processing apparatuses 100. That is, the information processing apparatus 100B may use a task list managed by the information processing apparatus 100A.

Specifically, a content written in a third sticky note is set as a ToDo item, a person in charge who is a user of an area in which the third sticky note is attached, a deadline and the like are set, and the progress thereof is managed. When the progress is changed, the content thereof is transmitted to the information processing apparatus 100.

The mount/sticky note information storage device 294 stores information on the mount and sticky notes. Each information processing apparatus 100 may perform a process using the mount/sticky note information storage device 294. In this case, the information on the mount and sticky notes in the mount/sticky note information storage device 294 may be shared by plural information processing apparatuses 100. That is, the information processing apparatus 100B may use the information on the mount and sticky note managed by the information processing apparatus 100A.

In addition, the user terminals 210 are used by participants of the gathering, create their own ToDo items and assign the content of the third sticky note generated at the gathering to their own ToDo items. In addition, the participants operate the user terminals 210 to register the progress status of a ToDo item in the task list management device 290.

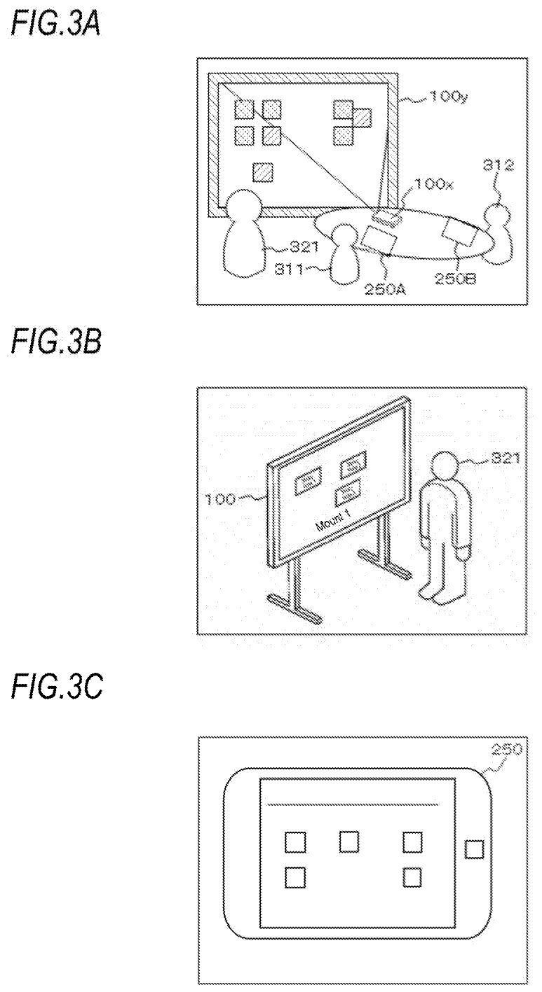

FIGS. 3A to 3C are explanatory views illustrating usage examples of the electronic sticky note terminal 250 and the information processing apparatus 100 in a conference room 280 or the like in which the present exemplary embodiment is used.

As illustrated in the example of FIG. 3A, participants 311 and 312 and a facilitator 321 are gathered in a conference room or the like. The participant 311 uses the electronic sticky note terminal 250A, and the participant 312 uses the electronic sticky note terminal 250B. Generally, one electronic sticky note terminal 250 is given to one participant. The electronic sticky note terminal 250 is a tablet type terminal whose size is about the size of a notebook (for example, A4, B5, 7 to 10 inches, etc.), like an electronic sticky note terminal 250 illustrated in the example of FIG. 3C. The electronic sticky note terminal 250 is operated using a finger, a pen or the like. The participant creates sticky note information in which text data, handwritten characters, figures and the like are written. The terminal device is not limited to a tablet terminal but may be a PC (including a notebook PC) or the like which is provided with a keyboard, a mouse and the like.

An information processing apparatus 100x illustrated in the example of FIG. 3A is a projector and displays a mount and sticky notes. In addition, an information processing apparatus 100y is an electronic white board, detects movement of a finger or pen of the facilitator 321 and receives operations such as attaching a sticky note on the mount, moving a sticky note, and grouping sticky notes. For example, a pen is provided in the information processing apparatus 100y. An operation on the mount and the sticky notes is received by detecting separation of the pen from a predetermined pen holder (specifically, lifting of the pen by the facilitator 321 for operation) and the position of the pen tip (specifically, touch of the pen tip to the information processing apparatus 100y, or the like). For example, the pen holder may be provided with a sensor (specifically, a sensor that switches on and off by gravity of the pen, or the like) to detect which of plural pens (specifically, a black pen, a red pen, a blue pen, and the like) is used. Further, the entire display screen of the information processing apparatus 100y may be a touch sensor to detect the position and pressure of touch of the pen on the display screen. In the present example, the switch on/off of the pen is controlled by the pen holder, but the pen holder does not necessarily have to be provided. It may be possible to control the switch on/off directly on the pen side. Regarding a color change, without requiring the pen holder, a color palette may be prepared on a part of the display screen and the color may be changed by touching a desired color with a finger or a pen, or a function of instructing the pen to change the color (specifically, a button, a slider or the like provided to exhibit the function) may be provided.

Further, the information processing apparatus 100 may be an electronic board as illustrated in the example of FIG. 3B. The electronic board generally has a large screen display device (at least larger than the display device of the electronic sticky note terminal 250), and the display device is a touch panel to detect the position and pressure of touch of a finger or pen on the display screen. For example, the screen may have a size such as 80 inches.

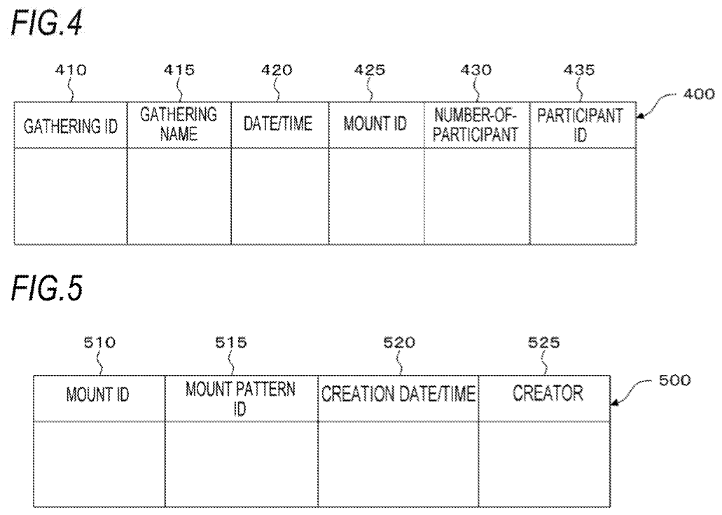

FIG. 4 is an explanatory view illustrating an example of the data structure of a gathering information table 400. The gathering information table 400 is managed by the attachment module 145. The gathering information table 400 includes a gathering ID column 410, a gathering name column 415, a date/time column 420, a mount ID column 425, a number-of-participants column 430, and a participant ID column 435. In the present exemplary embodiment, the gathering ID column 410 stores information for uniquely identifying a gathering (specifically, gathering identification (ID)). The gathering name column 415 stores a gathering name of the gathering. The date/time column 420 stores the date/time (the date/time may be year, month, day, hour, minute, second or less, or a combination thereof) or a period when the gathering is conducted. In the present exemplary embodiment, the mount ID column 425 stores information for uniquely identifying a mount used at the gathering (specifically, a mount ID). The number-of-participants column 430 stores the number of participants in the gathering. In the present exemplary embodiment, the participant ID column 435 stores information for uniquely identifying participants (specifically, a list of participant IDs).

FIG. 5 is an explanatory view illustrating an example of the data structure of a mount information table 500. The mount information table 500 is managed by the attachment module 145. The mount information table 500 includes a mount ID column 510, a mount pattern ID column 515, a creation date/time column 520, and a creator column 525. The mount ID column 510 stores a mount ID. The mount pattern ID column 515 stores a mount pattern ID which is a background. For example, there are a blank pattern, a tabular pattern, and the like. Furthermore, as the mount pattern, for example, a mount pattern for ToDo management may be used. Specifically, at the point when participants in the gathering are determined, sticky notes in each of which the name of the participant in the gathering is written or sticky notes in each of which a caricature icon is drawn may be attached in advance. Furthermore, a pattern in which a sticky note of each person in charge is attached on the vertical axis and an area is assigned to each person in charge may be prepared. The creation date/time column 520 stores the creation date/time of the mount. The creator column 525 stores the creator of the mount.

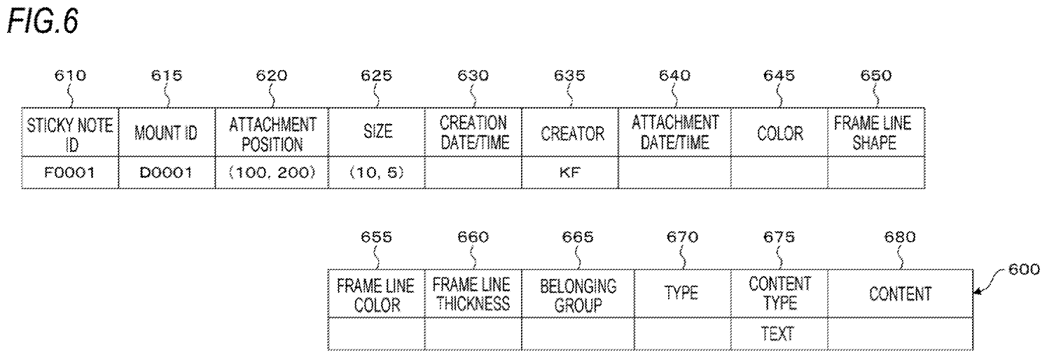

FIG. 6 is an explanatory view illustrating an example of the data structure of a sticky note information table 600. The sticky note information table 600 is managed by the attachment module 145. The sticky note information table 600 includes a sticky note ID column 610, a mount ID column 615, an attachment position column 620, a size column 625, a creation date/time column 630, a creator column 635, an attachment date/time column 640, a color column 645, a frame line shape column 650, a frame line color column 655, a frame line thickness column 660, a belonging group column 665, a type column 670, a content type column 675, and a content column 680. The sticky note ID column 610 stores an ID of a sticky note. The mount ID column 615 stores an ID of a mount on which the sticky note is attached. The attachment position column 620 stores a position at which the sticky note is attached. In other words, an attachment position on the mount is stored. For example, the attachment position is coordinates in the XY coordinate system of the mount (for example, the position of the center, the upper left end or the like of the sticky note). The size column 625 stores a size of the sticky note. For example, when a sticky note to be presented is a rectangle, the width and height of the sticky note are stored. The creation date/time column 630 stores the date/time when the sticky note is created. The creator column 635 stores the creator of the sticky note. Further, an information processing apparatus in which the sticky note is created (for example, a device ID of the electronic sticky note terminal 250 or the information processing apparatus 100) may be stored. The attachment date/time column 640 stores the date/time when the sticky note is attached on the mount. The color column 645 stores a display color of the sticky note. The frame line shape column 650 stores a shape of a frame line (for example, a solid line, a dotted line, a broken line, a wavy line, a double line, or the like) in displaying the sticky note. The frame line color column 655 stores a color of the frame line in displaying the sticky note. The frame line thickness column 660 stores a thickness of the frame line in displaying the sticky note. The belonging group column 665 stores information on a group to which the sticky note belongs. For example, information indicating whether the sticky note belongs to a group may be stored. When the sticky note belongs to a group, an ID of the group or an ID of another sticky note belonging to the group may be stored. The type column 670 stores the type of the sticky note. Specifically, there are a first sticky note in which an attribute of a task is written, a second sticky note in which a value of the attribute is written, and a third sticky note in which the task content is written. The content type column 675 stores the content type of the sticky note (for example, text information, vector data indicating handwritten characters or figures, voice information, still image information such as pictures, moving picture information, or combinations thereof). The content column 680 stores the content written in the sticky note.

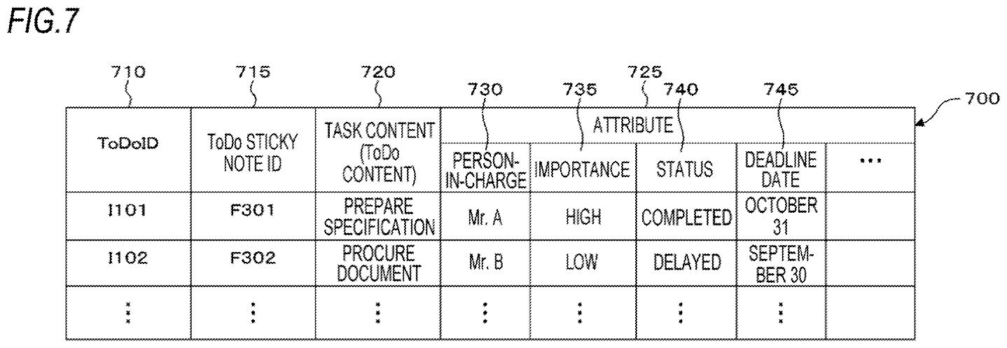

FIG. 7 is an explanatory view illustrating an example of the data structure of a ToDo management table 700. The ToDo management table 700 is stored in the task list storage module 105. The ToDo management table 700 includes a ToDo ID column 710, a ToDo sticky note ID column 715, a task content (ToDo content) column 720, and an attribute column 725. The attribute column 725 includes a person-in-charge column 730, an importance column 735, a status column 740, a deadline date column 745, and the like. In the present exemplary embodiment, the ToDo ID column 710 stores information for uniquely identifying ToDo (specifically, a ToDo ID). In the present exemplary embodiment, the ToDo sticky note ID column 715 stores information for uniquely identifying a ToDo sticky note (specifically, a ToDo sticky note ID). The task content (ToDo content) column 720 stores a task content (specifically, a ToDo content). The attribute column 725 stores an attribute. As specific contents of the attribute, there are the person-in-charge column 730 and the like. The person-in-charge column 730 stores a person in charge of the ToDo. The importance column 735 stores the importance of the ToDo. The status column 740 stores the status of the ToDo. Examples of the status of the ToDo include “completed” and “50% complete”. The deadline date column 745 stores the deadline date of the ToDo. The name of the person-in-charge column 730 or the like (for example, a “person in charge” or the like) is written as the first sticky note, the value in the person-in-charge column 730 or the like (for example, “Mr. A” or the like) is written as the second sticky note, and the value in the task content (ToDo content) column 720 (for example, “prepare a specification” or the like) is written as the third sticky note.

For example, as indicated in the first row of the ToDo management table 700, the ToDo ID of I101 has “F301” in the ToDo sticky note ID, “prepare a specification” in the task content (ToDo content), “Mr. A” in the person in charge, “high” in the importance, “completed” in the status, and “October 31” in the deadline date. As indicated in the second row of the ToDo management table 700, the ToDo ID of I102 has “F302” in the ToDo sticky note ID, “procure a document” in the task content (ToDo content), “Mr. B” in the person in charge, “low” in the importance, “delayed” in the status, and “September 30” in the deadline date.

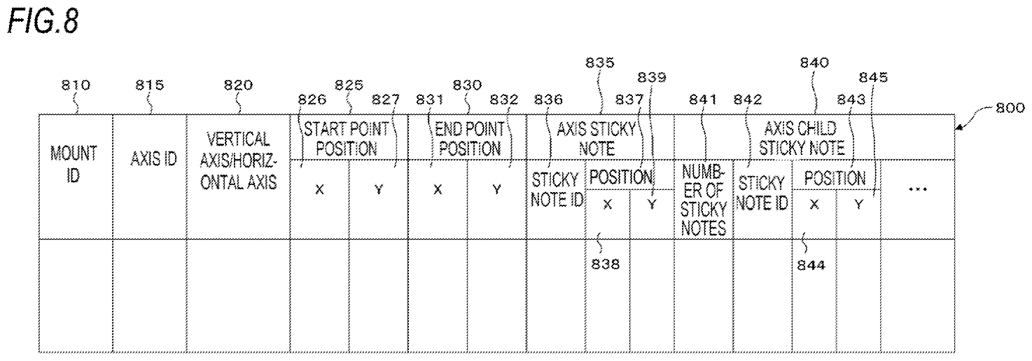

FIG. 8 is an explanatory view illustrating an example of the data structure of an in-mount axis management table 800. The in-mount axis management table 800 is managed by the attachment module 145. The in-mount axis management table 800 includes a mount ID column 810, an axis ID column 815, a vertical axis/horizontal axis column 820, a start point position column 825, an end point position column 830, an axis sticky note column 835, and an axis child sticky note column 840. The start point position column 825 has an X column 826 and a Y column 827. The end point position column 830 has an X column 831 and a Y column 832. The axis sticky note column 835 has a sticky note ID column 836 and a position column 837. The position column 837 has an X column 838 and a Y column 839. The axis child sticky note column 840 has a number-of-sticky-notes column 841, a sticky note ID column 842, and a position column 843. The position column 843 has an X column 844 and a Y column 845. The mount ID column 810 stores a mount ID. In the present exemplary embodiment, the axis ID column 815 stores information for uniquely identifying an axis (axis ID). The vertical axis/horizontal axis column 820 stores information as to whether the axis is the vertical axis or the horizontal axis. The start point position column 825 stores a start point position. The X column 826 stores an X coordinate of the start point position. The Y column 827 stores a Y coordinate of the start point position. The end point position column 830 stores an end point position. The X column 831 stores an X coordinate of the end point position. The Y column 832 stores a Y coordinate of the end point position. The axis sticky note column 835 stores a sticky note in which the name of the axis is written. The axis sticky note is a specific example of the first sticky note. The sticky note ID column 836 stores a sticky note ID. The position column 837 stores a position. The X column 838 stores an X coordinate. The Y column 839 stores a Y coordinate. The axis child sticky note column 840 stores an axis child sticky note attached on the axis. The axis child sticky note is a specific example of the second sticky note. The number-of-sticky-notes column 841 stores the number of sticky notes. The sticky note ID column 842 stores sticky note IDs. The position column 843 stores a position. The X column 844 stores an X coordinate. The Y column 845 stores a Y coordinate. A set of the sticky note ID column 842 and the position column 843 continues by the number in the number-of-sticky-notes column 841.

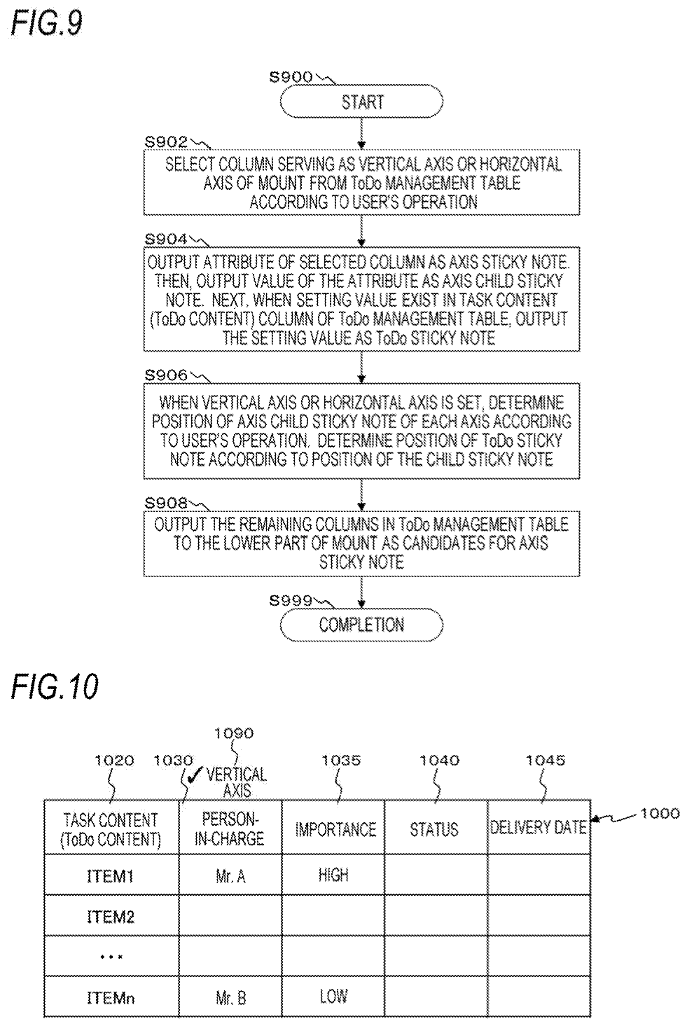

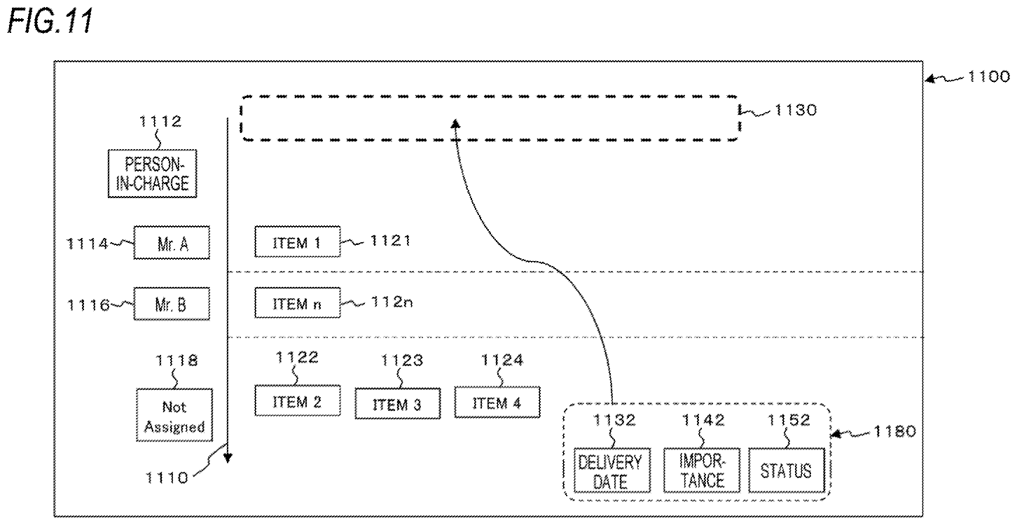

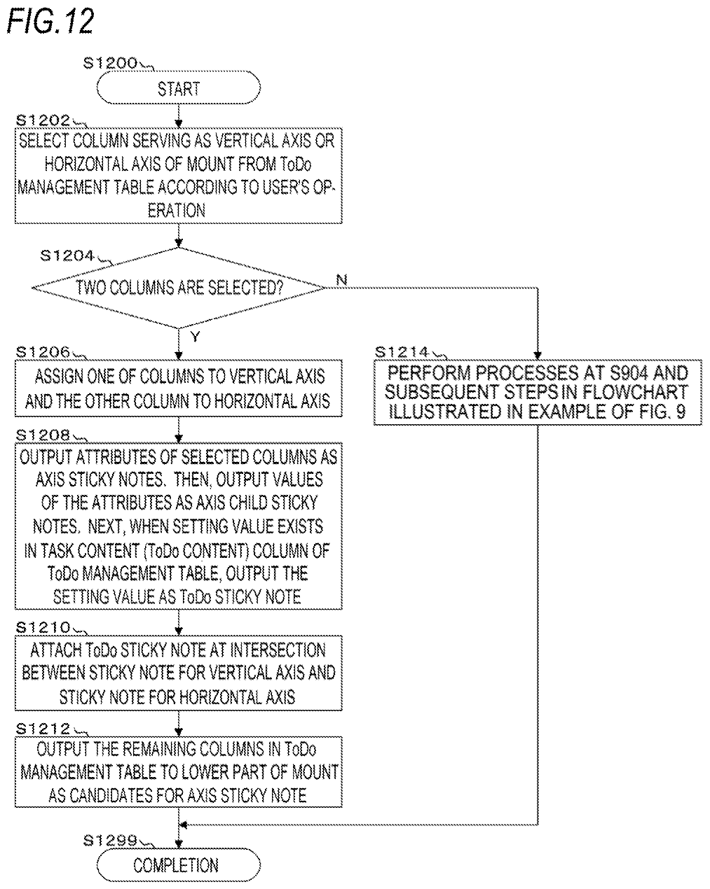

FIG. 9 is a flowchart illustrating an example of a process of carding a ToDo list. Here, the ToDo list is a specific example of the task list. The term “carding” includes generating sticky notes, determining an axis, and determining positions of the sticky notes (the phrase “determining the positions” may be referred to as “mapping”). The process is mainly performed by the sticky note generation module 120.

In step S902, a column serving as the vertical axis or horizontal axis of a mount is selected from the ToDo management table 700 according to a user's operation. This will be described with reference to an example illustrated in FIG. 10. For example, a display ToDo management table 1000 is displayed on the display device. FIG. 10 is an explanatory view illustrating an example of the data structure of the display ToDo management table 1000. The display ToDo management table 1000 is generated from the ToDo management table 700. The display ToDo management table 1000 is obtained by removing the ToDo ID column 710 and the ToDo sticky note ID column 715 from the ToDo management table 700. The display ToDo management table 1000 includes a task content (ToDo content) column 1020, a person-in-charge column 1030, an importance column 1035, a status column 1040, and a deadline date column 1045. The task content (ToDo content) column 1020 displays a task content (ToDo content). The person-in-charge column 1030 displays a person in charge. The importance column 1035 displays an importance. The status column 1040 displays a status. The deadline date column 1045 displays a deadline date. In the example of FIG. 10, given is an instruction 1090 to select the person-in-charge column 1030 as the vertical axis.

In step S904, the attribute of the selected column is output as a sticky note for an axis. This is a specific example of generation of the first sticky note. Then, the value of the attribute is output as an axis child sticky note. This is a specific example of generation of the second sticky note. Next, when a setting value exists in the task content (ToDo content) column 720 of the ToDo management table 700, the setting value is output as a ToDo sticky note. This is a specific example of generation of the third sticky note.

In step S906, when a vertical axis or a horizontal axis is set, a position of a child sticky note of each axis is determined according to a user's operation. Then, the position of the ToDo sticky note is determined according to the position(s) of the child sticky note(s).

In step S908, the remaining columns in the ToDo management table 700 are output to a lower portion of the mount as candidates for the sticky note for an axis. For example, when the person-in-charge column 730 of the ToDo management table 700 is selected in step S902, sticky notes in which the column names of the importance column 735, the status column 740, and the deadline date column 745 are respectively written are attached on the mount as candidates for the sticky note for an axis.

Description will be given with reference to an example illustrated in FIG. 11. FIG. 11 is an explanatory view illustrating an example of a process according to the present exemplary embodiment.

Since the person-in-charge column 1030 of the display ToDo management table 1000 is selected as a vertical axis, a vertical axis (person-in-charge axis) 1110 is drawn on a mount 1100.

A sticky note (person-in-charge) 1112 is generated as an axis sticky note of the vertical axis (person-in-charge axis) 1110. The sticky note (person-in-charge) 1112 is a sticky note having the column name of the person-in-charge column 1030 of the display ToDo management table 1000, that is, “person-in-charge” in this case, as a content thereof.

A sticky note (Mr. A) 1114, a sticky note (Mr. B) 1116, and a sticky note (Not Assigned) 1118 are generated as axis child sticky notes of the vertical axis (person-in-charge axis) 1110. The sticky note (Mr. A) 1114 and the sticky note (Mr. B) 1116 are sticky notes having the values in the person-in-charge column 1030, that is, “Mr. A” and “Mr. B” in this case, as contents thereof. Then, since blank columns exist in the person-in-charge column 1030 of the display ToDo management table 1000, the sticky note (Not assigned) 1118 is generated.

A sticky note (ITEM 1) 1121, a sticky note (ITEM 2) 1122, a sticky note (ITEM 3) 1123, a sticky note (ITEM 4) 1124, and a sticky note (ITEM n) 112n are generated as ToDo sticky notes of the vertical axis (person-in-charge axis) 1110. These sticky notes are generated based on the task content (ToDo content) column 1020 of the display ToDo management table 1000.

A sticky note (deadline date) 1132, a sticky note (importance) 1142, and a sticky note (status) 1152, which are candidates for an axis sticky note, are generated based on attribute names other than the selected person-in-charge column 1030 of the display ToDo management table 1000 (specifically, the deadline date column 1045, the importance column 1035, and the status column 1040). These are located in an area outside a space defined by the vertical axis (person-in-charge axis) 1110.

Candidates for the axis sticky note may be set in a horizontal axis area 1130. Specifically, when any of the sticky note (deadline date) 1132, the sticky note (importance) 1142, and the sticky note (status) 1152 is moved to the horizontal axis area 1130, a horizontal axis is generated and the position of the sticky note (ITEM 1) 1121 and the like are moved according to the attribute, corresponding to the sticky note, in the display ToDo management table 1000.

FIG. 12 is a flowchart illustrating an example of a process according to the present exemplary embodiment. While FIG. 9 illustrates the example of the process in a case where one axis is selected, FIG. 12 illustrates an example of a process in a case where two axes are selected.

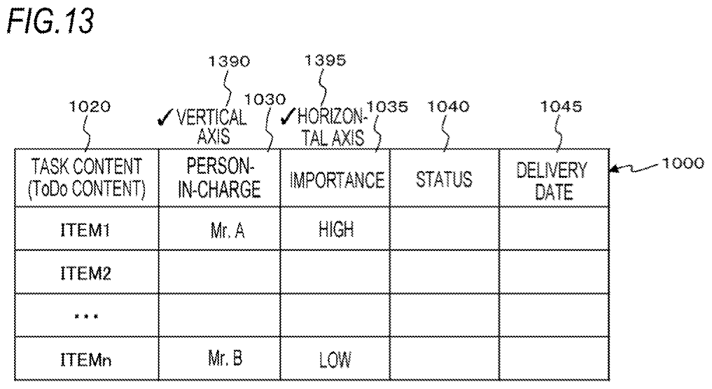

In step S1202, a column serving as a vertical axis or a horizontal axis of the mount is selected from the ToDo management table 700 according to a user's operation. This will be described with reference to an example of FIG. 13. For example, a display ToDo management table 1000 is displayed on the display device. This display ToDo management table 1000 is equivalent to the display ToDo management table 1000 illustrated in the example of FIG. 10. In the example of FIG. 13, given is an instruction 1390 to select the person-in-charge column 1030 as the vertical axis. An instruction 1395 to select the importance column 1035 as the horizontal axis is given.

In step S1204, it is determined whether two columns have been selected. When two columns have been selected, the process proceeds to step S1206. Otherwise, the process proceeds to step S1214.

In step S1206, one of the two columns is assigned to the vertical axis, and the other column is assigned to the horizontal axis.

In step S1208, the attributes of the selected columns are output as sticky notes for axes. Then, the values of the attributes are output as axis child sticky notes. Next, when a setting value exists in the task content (ToDo content) column 720 of the ToDo management table 700, the setting value is output as a ToDo sticky note.

In step S1210, the ToDo sticky note is attached at a position where a sticky note for a vertical axis and a sticky note for a horizontal axis intersect with each other.

In step S1212, the remaining columns in the ToDo management table 700 are output to the lower portion of the mount as candidates for a sticky note for an axis.

In step S1214, the processes at step S904 and subsequent steps in the flowchart illustrated in the example of FIG. 9 are performed.

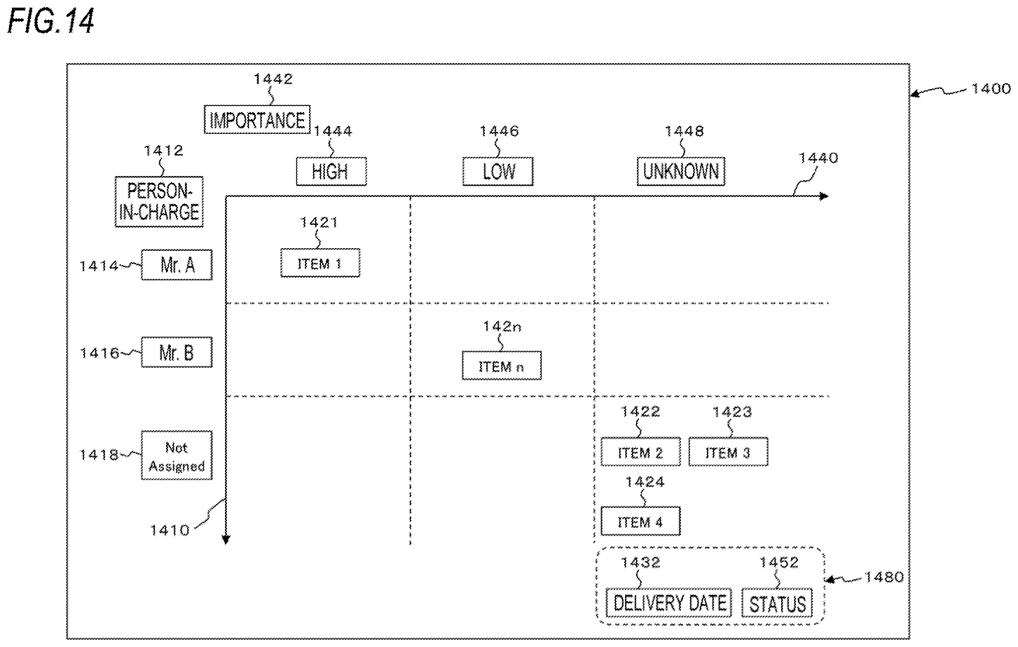

Description will be given with reference to an example of FIG. 14. FIG. 14 is an explanatory view illustrating an example of a process according to the present exemplary embodiment.

Since the person-in-charge column 1030 of the display ToDo management table 1000 is selected as the vertical axis, a vertical axis (person-in-charge axis) 1410 is drawn on a mount 1400.

Since the importance column 1035 of the display ToDo management table 1000 is selected as the horizontal axis, a horizontal axis (importance axis) 1440 is drawn on the mount 1400.

A sticky note (person-in-charge) 1412 is generated as an axis sticky note of the vertical axis (person-in-charge axis) 1410. The sticky note (person-in-charge) 1412 is a sticky note having the column name of the person-in-charge column 1030 of the display ToDo management table 1000, that is, “person-in-charge” in this case, as a content thereof.

A sticky note (Mr. A) 1414, a sticky note (Mr. B) 1416, and a sticky note (Not Assigned) 1418 are generated as axis child sticky notes of the vertical axis (person-in-charge axis) 1410. The sticky note (Mr. A) 1414 and the sticky note (Mr. B) 1416 are sticky notes having the values in the person-in-charge column 1030, that is, “Mr. A” and “Mr. B” in this case, as contents thereof. Then, since blank columns exist in the person-in-charge column 1030 of the display ToDo management table 1000, the sticky note (Not assigned) 1418 is generated.

A sticky note (importance) 1442 is generated as an axis sticky note of the horizontal axis (importance axis) 1440. The sticky note (importance) 1442 is a sticky note having the column name of the importance column 1035 of the display ToDo management table 1000, that is, “importance” in this case, as a content thereof.

A sticky note (high) 1444, a sticky note (low) 1446, and a sticky note (unknown) 1448 are generated as the axis child sticky notes of the horizontal axis (importance axis) 1440. The sticky note (high) 1444 and the sticky note (low) 1446 are sticky notes having the values in the importance column 1035, that is, “high” and “low” in this case, as the contents thereof. Then, since blank columns exist in the importance column 1035 of the display ToDo management table 1000, the sticky note (unknown) 1448 is generated.

Then, a sticky note (ITEM 1) 1421, a sticky note (ITEM 2) 1422, a sticky note (ITEM 3) 1423, a sticky note (ITEM 4) 1424, and a sticky note (ITEM n) 142n are generated as ToDo sticky notes of the vertical axis (person-in-charge axis) 1410 and horizontal axis (importance axis) 1440. These sticky notes are generated based on the task content (ToDo content) column 1020 of the display ToDo management table 1000. The positions of these sticky notes are determined based on the positions of the axis child sticky notes on the vertical axis (person-in-charge axis) 1410 and the positions of the axis child sticky notes on the horizontal axis (importance axis) 1440. In other words, the sticky note (ITEM 1) 1421 is attached at the intersection between the sticky note (Mr. A) 1414 and the sticky note (high) 1444, the sticky note (ITEM n) 142n is attached at the intersection between the sticky note (Mr. B) 1416 and the sticky note (low) 1446, and the sticky note (ITEM 2) 1422, the sticky note (ITEM 3) 1423, and the sticky note (ITEM 4) 1424 are attached at the intersection between the sticky note (Not Assigned) 1418 and the sticky note (unknown) 1448.

A sticky note (deadline date) 1432 and a sticky note (status) 1452, which are candidates for the axis sticky note, are created based on attribute names other than the selected person-in-charge column 1030 and importance column 1035 of the display ToDo management table 1000 (specifically, the deadline date column 1045 and the status column 1040). These sticky notes are attached in an area outside a space defined by the vertical axis (person-in-charge axis) 1110 and the horizontal axis (importance axis) 1440.

Here, the sticky note (deadline date) 1432 or the sticky note (status) 1452 may be attached instead of the sticky note (person-in-charge) 1412 or the sticky note (importance) 1442. In that case, an axis child sticky note(s) are generated according to values in the deadline date column 1045 or the status column 1040. In the case of the display ToDo management table 1000 illustrated in the example of FIG. 10, the status column 1040 and the deadline date column 1045 are blank. Therefore, one sticky note in which “unknown” is written is generated and attached on the axis.

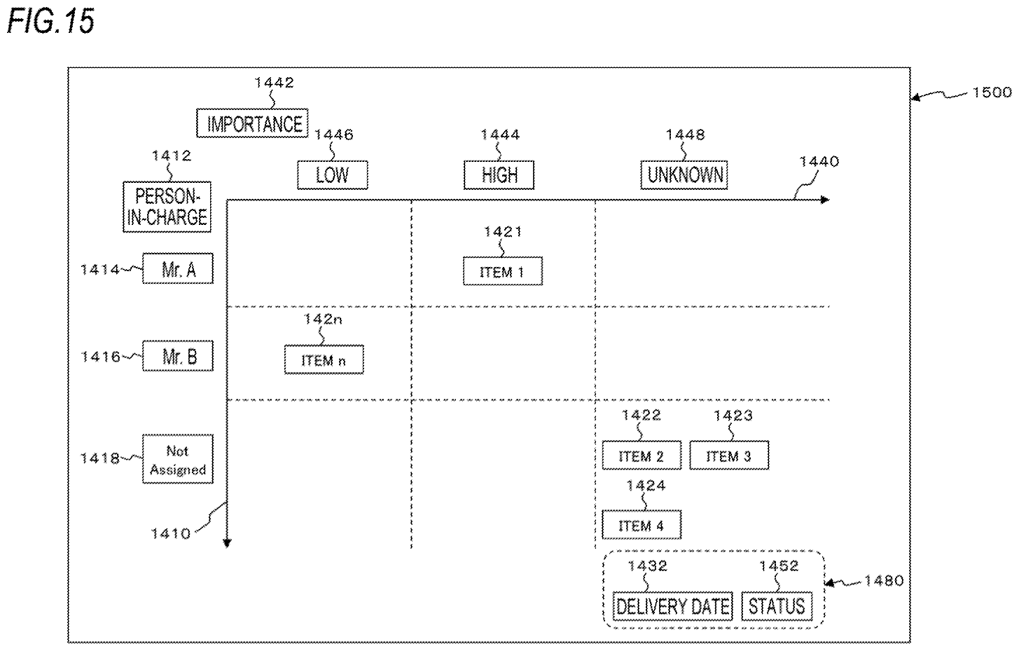

FIG. 15 is an explanatory view illustrating an example of a process according to the present exemplary embodiment.

When a sticky note for an axis is moved by a user's operation, a child sticky note of the axis is also moved along with the movement.

The example of FIG. 15 illustrates change of the position of the axis child sticky note illustrated in the example of FIG. 14. Specifically, when the user exchanges the position of the sticky note (high) 1444 and the position of the sticky note (low) 1446, the position of the sticky note (ITEM 1) 1421 and the position of the sticky note (ITEM n) 142n are changed accordingly. Surely, (i) attaching the sticky note (ITEM 1) 1421 at the intersection between the sticky note (Mr. A) 1414 and the sticky note (high) 1444 and (ii) attaching the sticky note (ITEM n) 142n at the intersection between the sticky note (Mr. B) 1416 and the sticky note (low) 1446 are the same as in the example of FIG. 14.

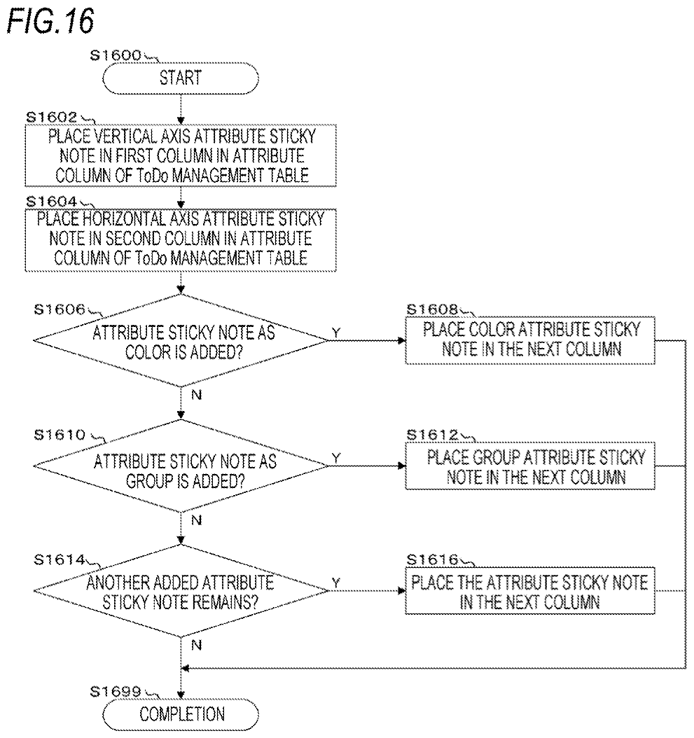

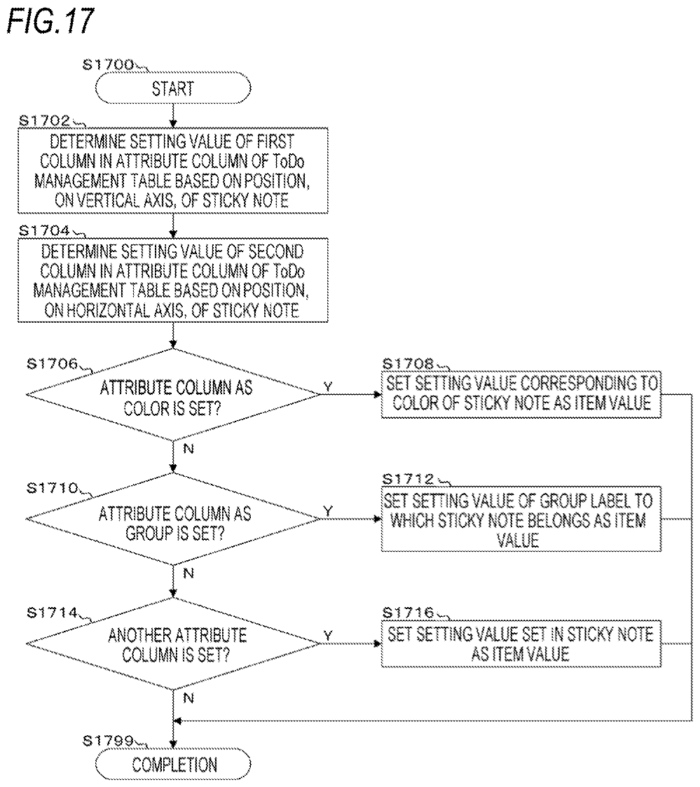

An example of a process of generating a ToDo list from sticky notes attached on a mount will be described. Processes illustrated in examples of FIGS. 16 and 17 are performed.

FIG. 16 is a flowchart illustrating an example of a process of determining columns in listing ToDos.

In step S1602, a vertical axis attribute sticky note is placed in the first column in the attribute column 725 of the ToDo management table 700. Specifically, a sticky note which is attached in the vicinity of the vertical axis on the mount and which has the first sticky note as a type in the type column 670 of the sticky note information table 600 may be extracted.

In step S1604, a horizontal axis attribute sticky note is placed in the second column in the attribute column 725 of the ToDo management table 700. Specifically, a sticky note which is attached in the vicinity of the horizontal axis on the mount and which has the first sticky note as a type in the type column 670 of the sticky note information table 600 may be extracted.

In step S1606, it is determined whether an attribute sticky note as a color is added. When such an attribute sticky note is added, the process proceeds to step S1608. Otherwise, the process proceeds to step S1610.

In step S1608, the color attribute sticky note is placed in the next column. Specifically, a colored sticky note may be extracted from the color column 645 of the sticky note information table 600.

In step S1610, it is determined whether an attribute sticky note as a group is added. When such an attribute sticky note is added, the process proceeds to step S1612. Otherwise, the process proceeds to step S1614. Specifically, a sticky note to which a group is assigned may be extracted from the belonging group column 665 of the sticky note information table 600.

In step S1612, the group attribute sticky note is placed in the next column.

In step S1614, it is determined whether another added attribute sticky note remains. When the another added attribute sticky note remains, the process proceeds to step S1616. Otherwise, the process is ended (step S1699). Specifically, a sticky note to which an attribute is assigned may be extracted from the frame line shape column 650, the frame line color column 655 and the like of the sticky note information table 600.

In step S1616, the attribute sticky note is placed in the next column.

FIG. 17 is a flowchart illustrating an example of a process of setting a sticky note as an itemization of a ToDo list.

In step S1702, a setting value of the first column in the attribute column 725 of the ToDo management table 700 is determined based on the position, on the vertical axis, of the sticky note.

In step S1704, a setting value of the second column in the attribute column 725 of the ToDo management table 700 is determined based on the position, on the horizontal axis, of the sticky note.

In step S1706, it is determined whether an attribute column as a color is set. When such an attribute column is set, the process proceeds to step S1708. Otherwise, the process proceeds to step S1710.

In step S1708, a setting value corresponding to the color of the sticky note is set as an item value.

In step S1710, it is determined whether an attribute column as a group is set. When such an attribute column is set, the process proceeds to step S1712. Otherwise, the process proceeds to step S1714.

In step S1712, a setting value of a group label to which the sticky note belongs is set as an item value.

In step S1714, it is determined whether another attribute column is set. When the another attribute column is set, the process proceeds to step S1716. Otherwise, the process is ended (step S1799).

In step S1716, a setting value set in the sticky note is set as an item value.

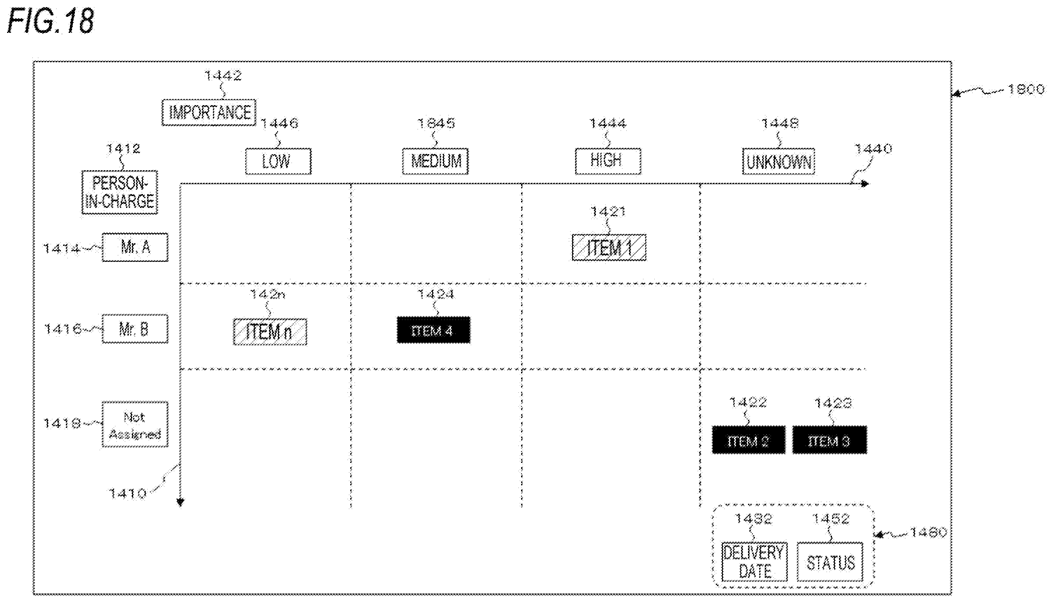

FIG. 18 is an explanatory view illustrating an example of a process according to the present exemplary embodiment. FIG. 18 illustrates an example in which a sticky note (medium) 1845 is added to the example of FIG. 15.

Colors of sticky notes indicate the statuses of ToDo items. Specifically, red sticky notes (a black sticky note (ITEM 2) 1422, a black sticky note (ITEM 3) 1423, a black sticky note (ITEM 4) 1424 in the example of FIG. 18) indicate that the status is 0% in progress. Blue sticky notes (a hatched sticky note (ITEM 1) 1421 and a hatched sticky note (ITEM n) 142n in the example of FIG. 18) indicate that the status is 80% in progress.

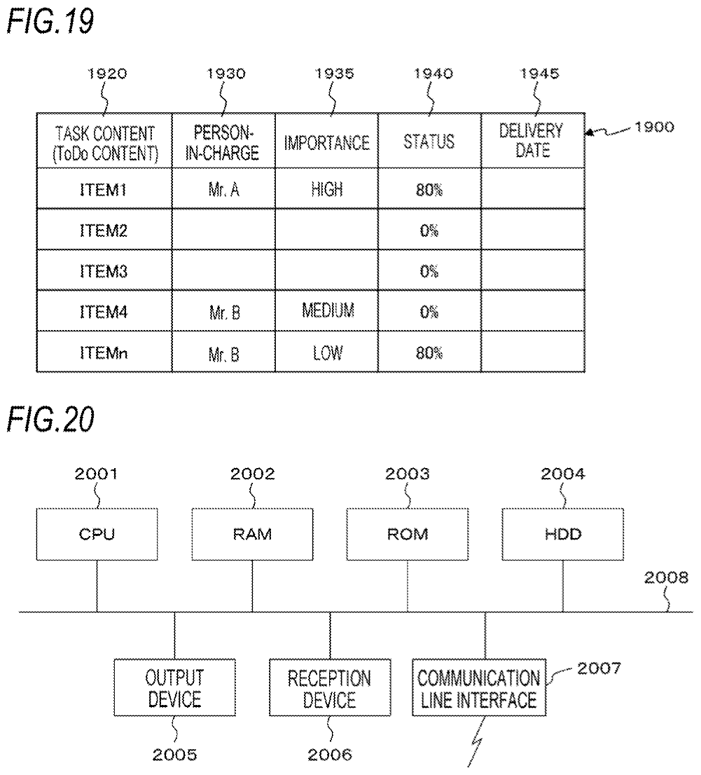

A display ToDo management table 1900 is generated from the sticky notes in the mount 1800 illustrated in the example of FIG. 18. FIG. 19 is an explanatory view illustrating an example of the data structure of the display ToDo management table 1900.

The display ToDo management table 1900 includes a task content (ToDo content) column 1920, a person-in-charge column 1930, an importance column 1935, a status column 1940 and a deadline date column 1945. The task content (ToDo content) column 1920 stores a task content (ToDo content). The person-in-charge column 1930 stores a person in charge. The importance column 1935 stores an importance. The status column 1940 stores a status. The deadline date column 1945 stores a deadline date.

The display ToDo management table 1900 is generated (or the display ToDo management table 1000 is corrected) according to the positions and attributes of the sticky notes in the mount 1800 illustrated in the example of FIG. 18 (the colors of the sticky notes in the example of FIG. 18). Specifically, since the sticky note (ITEM 1) 1421 is located at the intersection between the sticky note (Mr. A) 1414 and the sticky note (high) 1444 and the color thereof is blue, the person in charge (the person-in-charge column 1930) is “Mr. A”, the importance (the importance column 1935) is “high”, and the status (the status column 1940) is “80%” as indicated in the first row of the display ToDo management table 1900. Since the sticky note (ITEM 2) 1422 is located at the intersection between the sticky note (Not Assigned) 1418 and the sticky note (unknown) 1448 and the color thereof is red, the person in charge (the person-in-charge column 1930) is “Not Assigned (blank)”, the importance (the importance column 1935) is “unknown (blank)”, and the status (the status column 1940) is “0%” as indicated in the second row of the display ToDo management table 1900. Since the sticky note (ITEM 3) 1423 is located at the intersection between the sticky note (Not Assigned) 1418 and the sticky note (unknown) 1448 and the color thereof is red, the person in charge (the person-in-charge column 1930) is “Not Assigned (blank)”, the importance (the importance column 1935) is “unknown (blank)”, and the status (the status column 1940) is “0%” as indicated in the third row of the display ToDo management table 1900. Since the sticky note (ITEM 4) 1424 is located at the intersection between the sticky note (Mr. B) 1416 and the sticky note (medium) 1845 and the color thereof is red, the person in charge (the person-in-charge column 1930) is “Mr. B”, the importance (the importance column 1935) is “medium”, and the status (the status column 1940) is “0%” as indicated in the fourth row of the display ToDo management table 1900. Since the sticky note (ITEM n) 142n is located at the intersection between the sticky note (Mr. B) 1416 and the sticky note (low) 1446 and the color thereof is blue, the person in charge (the person-in-charge column 1930) is “Mr. B”, the importance (the importance column 1935) is “low”, and the status (the status column 1940) is “80%” as indicated in the fifth row of the display ToDo management table 1900.

The hardware configuration of a computer on which a program according to the present exemplary embodiment is executed is a general-purpose computer, specifically, a personal computer, a computer serving as a server, or the like, as exemplified in FIG. 20. That is, as a specific example, a CPU 2001 is used as a processing unit (arithmetic unit), and a RAM 2002, a ROM 2003 and a HDD 2004 are used as storage devices. A hard disk drive (HDD) and a solid state drive (SSD), which is a flash memory, may be used as the HDD 2004.

The computer includes the CPU 2001 which executes programs of the sticky note/task list management module 110, the task list generation module 115, the sticky note generation module 120, the operation reception module 125, the sticky note processing module 130, the conversion module 135, the movement module 140, the attachment module 145 and the display module 150, the RAM 2002 which stores the programs and data, the ROM 2003 in which programs that activates the computer are stored, the HDD 2004 which serves as an auxiliary storage device having the function as the task list storage module 105, a reception device 2006 which receives data based on a user's operation (including actions, sounds, line of sight) on a keyboard, a mouse, a touch screen, a microphone, a camera (including a line-of-sight detection camera, etc.), etc., an output device 2005 such as a CRT, a liquid crystal display, or a speaker, a communication line interface 2007 which connects with a communication network such as a network interface card, and a bus 2008 which interconnects these components for data exchange. Plural computers implemented by the above-mentioned components may be interconnected via a network.

Those implemented by computer programs among the above-described exemplary embodiments are implemented by reading a computer program, which is software, into a system of this hardware configuration and executing software and hardware resources in cooperation.

The hardware configuration illustrated in FIG. 20 is merely one example. The present exemplary embodiment is not limited to the configuration illustrated in FIG. 20 but may be implemented with any configuration as long as the modules described in the present exemplary embodiment may be executed. For example, a part of the modules may be configured with dedicated hardware (for example, an application specific integrated circuit (ASIC), a reconfigurable field-programmable gate array (FPGA), etc.), a part of the modules may be in an external system and may be connected via a communication line. Further, plural systems illustrated in FIG. 20 may be interconnected via a communication line so as to operate in cooperation. The modules may be installed in a portable information communication device (including a mobile phone, a smartphone, a mobile device, a wearable computer, etc.), an information home appliance, a robot, a copier, a facsimile machine, a scanner, a printer, a copier, a multifunction machine (an image processing apparatus having at least two functions of a scanner, a printer, a facsimile machine, etc.), or the like, in addition to the personal computer.

The program described above may be stored in a recording medium or may be provided by a communication unit. In that case, for example, the program described above may be understood as “a non-transitory computer readable medium storing a program”.

The “non-transitory computer readable medium storing a program” refers to a non-transitory computer readable medium in which a program is stored and which is used for installation, execution, distribution and so on of programs.

Examples of the recording medium may include a digital versatile disc (DVD) which is a standard formulated by the DVD forum, such as “DVD-R, DVD-RW, or DVD-RAM”, “DVD+R, DVD+RW, etc.” which are standards formulated by DVD+RW, a compact disc (CD), a read only memory (CD-ROM), a CD recordable (CD-R), a CD rewritable (CD-RW), a Blu-ray (registered trademark) disc, a magneto-optical disc (MO), a flexible disc (FD), a magnetic tape, a hard disk, a read only memory (ROM), an electrically erasable and rewritable read only memory (EEPROM (registered trademark)), a flash memory, a random access memory (RAM), an SD (Secure Digital) memory card, and the like.

The whole or part of the above-described program may be recorded in the recording medium for storage, distribution and the like. Further, the whole or part of the above-described program may be transmitted by communications using a transmission medium such as a wired network, a wireless communication network or a combination thereof that is used for a local area network (LAN), a metropolitan area network (MAN), a wide area network (WAN), the Internet, an intranet, an extranet and the like, or may be carried on a carrier wave.

Further, the above-described program may be a part or the whole of another program, or may be recorded on a recording medium together with a separate program. Further, the program may be divided and recorded in plural recording media. Further, the program may be recorded in any form such as compression or encryption as long as it may be restored.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a sticky note generator configured to generate, from a task list, a first sticky note corresponding to an attribute of a task, a second sticky note corresponding to a value of the attribute, and a third sticky note corresponding to a task content of the task list; and
an attachment unit configured to
locate the first sticky note and the second sticky note on an axis, and
attach the third sticky note at a position corresponding to the second sticky note.

2. The information processing apparatus according to claim 1, wherein the attachment unit locates the first sticky note corresponding to a selected attribute and the second sticky note on the axis.

3. The information processing apparatus according to claim 2, wherein the attachment unit locates a first sticky note corresponding to a non-selected attribute at a location different from the axis.

4. The information processing apparatus according to claim 1, wherein when a task content in which a value of the attribute is not set exists, the sticky note generator generates a second sticky note indicating that the value of the attribute is not set.

5. The information processing apparatus according to claim 1, wherein when two attributes are selected, the attachment unit attaches the first, second, and third sticky notes while assigning one of the two attributes to a vertical axis and the other of the two attributes to a horizontal axis.

6. The information processing apparatus according to claim 1, further comprising:
a conversion unit configured to, when a sticky note generated by an operator is attached on a position corresponding to the second sticky note, convert the sticky note into the third sticky note.

7. The information processing apparatus according to claim 1, further comprising:
a movement unit configured to, when the second sticky note is moved, move the third sticky note along with the movement of the second sticky note.

8. The information processing apparatus according to claim 6, further comprising:
a task list generator configured to generate a task list from the first, second and third sticky notes.

9. The information processing apparatus according to claim 7, further comprising:
a task list generator configured to generate a task list from the first, second and third sticky notes.

10. A non-transitory computer readable medium storing a program that causes a computer to execute information processing, the information processing comprising:
generating, from a task list, a first sticky note corresponding to an attribute of a task, a second sticky note corresponding to a value of the attribute, and a third sticky note corresponding to a task content of the task list;
locating the first sticky note and the second sticky note on an axis, and
attaching the third sticky note at a position corresponding to the second sticky note.

11. An information processing apparatus comprising:
means for generating, from a task list, a first sticky note corresponding to an attribute of a task, a second sticky note corresponding to a value of the attribute, and a third sticky note corresponding to a task content of the task list; and
means for
locating the first sticky note and the second sticky note on an axis, and
attaching the third sticky note at a position corresponding to the second sticky note.
